(19) United States
(12) Patent Application Publication
(10) Pub. No.: US 2012/0100351 A1
(43) Pub. Date: Apr. 26, 2012

(54) BONDED FABRIC CONSTRUCTIONS WITH STRETCHABILITY

(75) Inventors: Carmen A. Covelli, Chadds Ford, PA (US); Douglas K. Farmer, Greensboro, NC (US); Geoffrey D. Hietpas, Newark, DE (US)

(73) Assignee: INVISTA North America S.a.r.l., Wilmington, DE (US)

(21) Appl. No.: 13/318,481

(22) PCT Filed: May 7, 2010
(86) PCT No.: PCT/US10/33962

§ 371 Date: Jan. 12, 2012

(51) Int. Cl. B32B 7/14; B32B 7/12; B32B 5/18; B32B 5/24; B32B 5/26; A41D 19/00; B32B 3/00; B32B 37/12; A41D 1/00; A41B 11/00; A42B 1/00; A41B 9/00; B32B 5/02; B32B 3/26

(52) U.S. Cl. 428/196; 428/221; 428/354; 442/183; 442/315; 442/318; 442/319; 442/328; 428/349; 428/317.1; 428/98; 156/290; 2/69; 2/239; 2/171; 2/400; 2/159

(57) ABSTRACT

Included are bonded laminate constructions that have a modulus which approaches the sum of the modulus of the individual components of the laminate. By reducing variation in the modulus, the stretch or elasticity of the bonded or laminated fabric or garment is maximized. The bonded laminates include a bonding component that may be an elastomeric film, an adhesive, or a combination of a film with adhesive.

### BACKGROUND OF THE INVENTION

1. Field of the Invention

The present invention relates to fabrics and articles which are garments that have at least one area bonded or adhered to a bonding component selected from an elastomeric polymer film and an adhesive where the area may include an edgeband or seam. The invention is related to the stretch and recovery properties of bonded fabrics (seams, hems, zones, or other fabric/garment areas) being greatly affected considering the fabric construction and stitch movement.

2. Summary of Related Technology

Polyurethaneurea films and tapes are elastomeric polymer films that provide stretch recovery as disclosed in U.S. Pat. No. 7,240,371. Other examples of commercially available polymer films include polyurethane films available from Bemis Associates. These films may be bonded to fabric with application of heat or adhered by sewing, gluing (using an adhesive) or any other acceptable method of fabric attachment.

Such polymer films and adhesives have been used to bond fabric in locations such as at seams and edgebands (such as the leg and waist openings of panties). This can be accomplished by folding over the fabric to form a first and second fabric layer between which the polymer film or adhesive is placed and adhered or bonded. However, such constructions generally result in loss of stretch of the fabric at the point of bonding regardless of the elasticity of the film or adhesive. A similar effect has been noted when bonded seams or shapewear is desired.

### SUMMARY OF THE INVENTION

There is a need for alternative bonded laminate constructions that have modulus which approach to the sum of the modulus of the individual components of the laminate. If the modulus of the individual components could be maintained after adhering or bonding, the elasticity of the bonded garment would be maximized.

In one aspect is an article including a first substrate, a second substrate and a bonding component between said first substrate and said second substrate;
wherein the bonding component is selected from the group consisting of an elastomeric polymer film, an adhesive, and combinations thereof;
at least one of said first substrate and said second substrate includes a fabric layer;
the first substrate and the second substrate together include a selected direction of stretch selected from the warp direction, the weft direction, and combinations thereof;
at least one of the first substrate and the second substrate independently include stretchable yarn structures that stretch in a direction selected form the group consisting of the warp direction, the weft direction, and combinations thereof;
the elastic component is adhered to the first substrate and the second substrate to form bonds; and
the bonds between the elastic component and yarns in selected direction of stretch are minimized.

The bonds between the elastic component and the yarns in the selected direction of stretch, may be minimized, and stretch consequently optimized or increased, by providing one or more laminate constructions. The fabrics in the laminate may be oriented to decrease exposure of yarns on the surface, to which the adhesive or film will bond. Alternatively, the adhesive or film may be constructed in a way that reduces bonding, such as by discontinuous application of the adhesive or film. Another suitable alternative is to provide a specific fabric orientation with a specific adhesive or film geometry that together serves to increase stretch in the desired direction(s) of stretch.

Another aspect provides an article including a first substrate, a second substrate and an elastic component between the first substrate and the second substrate;
wherein the first substrate comprises a fabric having opposing sides comprising a technical face and a technical back;
the second substrate comprises a fabric or a foam;
the elastic component comprises a film or adhesive selected from the group consisting of polyurethanes, polyurethaneureas, polyolefins, and combinations thereof;
the elastic component is adhered to the first substrate and the second substrate to form bonds; at least one of the technical face or the technical back of the first substrate includes yarn structures that stretch in a selected direction selected from the group consisting of the warp direction, the weft direction, and combinations thereof;
the bonds of the elastic component to the yarn structures that stretch in the selected direction are minimized.

A further aspect provides an article including a fabric layer and an elastic component,
wherein the elastic component is a polymer film selected from the group consisting of elastomeric polyolefins and polyurethanes;
the fabric layer includes a selected direction of stretch selected from the warp direction, the weft direction, and combinations thereof;
the fabric layer includes stretchable yarn structures that stretch in the selected direction of stretch;
the elastic component is adhered to the fabric layer to form bonds; and
the bonds between the elastic component and yarn structures that stretch in the selected direction of stretch are minimized.

Included is a method of preparing an article including a fabric layer and an elastic component, the method including:
providing an the elastic component as a polymer film selected from the group consisting of elastomeric polyolefins and polyurethanes;
providing a fabric layer including a selected direction of stretch selected from the warp direction, the weft direction, and combinations thereof wherein the fabric layer includes stretchable yarn structures that stretch in the selected direction of stretch;
adhering the elastic component to the fabric layer to form bonds; and
minimizing the bonds between the elastic component and yarn structures that stretch in the selected direction of stretch.

### BRIEF DESCRIPTION OF THE DRAWINGS

FIGS. 1-2 are photos showing the technical back and technical face, respectively, of a circular knit fabric.

FIGS. 3A-3F and 4A-4B show the force versus elongation for the laminates of several embodiments in a selected direction of stretch.

FIGS. 5-6 are photos showing the technical face and technical back, respectively, of a warp knit fabric.

FIG. 7 shows the force versus elongation for a twill fabric.

FIG. 8 includes photos showing the technical back and face as indicated for a woven twill fabric.

FIG. 9 shows force versus elongation for a laminate of one aspect.

### DETAILED DESCRIPTION OF THE INVENTION

As used herein, the term “porous” refers to a substrate that includes voids or holes in the surface or at any point within or through the thickness of the substrate or to any material of which the articles of the present invention may come into contact.

As used herein, the term “foam” refers to any suitable foam that may be used in fabric construction such as polyurethane foam.

As used herein, the term “laminate” refers to an article that is comprised of two fabric layers bonded with an adhesive layer or film layer between the fabric layers.

As used herein the term “face” or “front” refers to the fabric side that is defined as the technical face, this can be the side of the fabric which in garment form is chosen to be displayed.

As used herein the term “back” refers to the fabric side that is defined as the technical back, this can be the side of the fabric which in garment form is chosen to be worn against or closest to the body.

As used herein the term “warp” refers to the machine direction of the fabric

As used herein the term “weft” refers to cross direction of the fabric.

As used herein, the term “pressing” or “pressed” refers to an article that has been subjected to heat and/or pressure to provide a substantially planar structure.

As used herein, the term “orientation of 0°” means that the warp and weft directions of a first fabric are aligned with the warp and weft directions, respectively, of a second fabric. Where one of the first or second fabrics is rotated 90° with respect to the other fabric, the orientation is 90°. In other words, “orientation of 90°” means that the warp direction of a first fabric is aligned with the weft direction of the second fabric and the weft direction of the first fabric is aligned with the warp direction of the second fabric. Orientations of about 0° to about 90° are also contemplated, for example, 0° to about 15°, including about 0° to about 5° and about 75° to about 90°, including about 85° to about 90°.

For fabric laminates (adhesive or polymer film bonding at least two layers of fabric) described herein where more two fabric layers are included, the warp and weft direction of the laminate is defined as being the warp and weft direction of the first fabric.

As used herein, the term “dispersion” refers to a system in which the disperse phase consists of finely divided particles, and the continuous phase can be a liquid, solid or gas.

As used herein, the term “aqueous polyurethane dispersion” refers to a composition containing at least a polyurethane or polyurethane urea polymer or prepolymer (such as the polyurethane prepolymer described herein), optionally including a solvent, that has been dispersed in an aqueous medium, such as water, including de-ionized water.

As used herein, the term “solvent,” unless otherwise indicated, refers to a non-aqueous medium, wherein the non-aqueous medium includes organic solvents, including volatile organic solvents (such as acetone) and somewhat less volatile organic solvents (such as MEK, or NMP).

As used herein, the term “solvent-free” or “solvent-free system” refers to a composition or dispersion wherein the bulk of the composition or dispersed components has not been dissolved or dispersed in a solvent.

As used herein, the term “article” refers to an article which comprises a dispersion or shaped article and a substrate, for example a textile fabric, which may or may not have at least one elastic property, in part, due to the application of a dispersion or shaped article as described herein. The article may be in any suitable configuration such as one-dimensional, two-dimensional and/or three-dimensional.

As used herein, the term “fabric” refers to a knitted, woven or nonwoven material. The knitted fabric may be flat knit, circular knit, warp knit, narrow elastic, and lace. The woven fabric may be of any construction, for example sateen, twill, plain weave, oxford weave, basket weave, and narrow elastic. The nonwoven material may be meltblown, spun bonded, wet-laid, carded fiber-based staple webs, and the like.

As used herein, the term “substrate” refers to any material to which the articles of the present invention may come into contact. A substrate can be substantially one dimensional as is a fiber, two dimensional as in a planar sheet, or a three dimensional article or a bumpy sheet. A planar sheet for example may comprise textile fabric, paper, flocked article, and web. A three dimensional article for example may comprise leather and foam.

As used herein, the term “hard yarn” refers to a yarn which is substantially non-elastic.

As used herein, the term “molded” article refers to a result by which the shape of an article or shaped article is changed in response to application of heat and/or pressure.

As used herein, the term “derived from” refers to forming a substance out of another object. For example, a film may be derived from a dispersion which can be dried.

As used herein, the term “modulus” refers to a ratio of the stress to strain on an item expressed in force per area. The percent increase in modulus is calculated using a fixed strain over a range of elongation.

As used herein, the term “stretchable yarn structure” means a portion or portions of a fabric that may be stretched.

As used herein, the term “bonding component” refers to the composition that adheres to a fabric layer or adheres two or more fabric layers to form a fabric laminate. The bonding component may be in any suitable form including, but not limited to, an adhesive either solid or liquid form, an elastic or elastomeric polymer film, or any combination of thereof.

As used herein, the term “elastic component” refers to a bonding component that is elastic or elastomeric. Suitable examples include elastomeric films such as those including polyurethanes, polyurethaneureas, metallocene-catalyzed polyolefins (such as the elastomeric polyolefins available under the trade name “VISTAMAXX” from ExxonMobil), and combinations thereof.

The articles of some embodiments encompass the use of fabrics which are anisotropic; meaning that the fabric characteristics including but not limited to stretch, physical appearance, hysteresis and modulus are dependent on the direction of testing; for example the modulus or force to elongation response for the fabric tested in the weft or cross direction is not equal to that of the fabric tested in the warp or machine direction. In particular, fabrics that have a varied stitch appearance on each of the two sides of the fabric, (face and back and fabrics) frequently include an elastic yarn.

The bonded or laminated article of some aspects may have a modulus equal to or less than 1.25 times the sum of the modulus of the first substrate, the bonding component and the second substrate in the absence of adhesion or bonding, including a modulus equal to or less than the 1.5 times the sum of the modulus of the first substrate, the elastic component and the second substrate in the absence of adhesion or bonding, and less than the 2 times the sum of the modulus of the first substrate, the elastic component and the second substrate in the absence of adhesion or bonding.

The articles including the laminates or bonded fabrics of any aspect may be garments. Examples of garments include, but are not limited to, group consisting of tops, bottoms, hosiery, seamless garments, headwear, underwear, and gloves.

Included in the articles of some embodiments are a broad range of films and adhesives including but are not limited to PUU, TPU, polyamides, polyolefins, polyesters and hot melt polyesters and polyamides. Suitable examples of compositions that may be used as films include of polyurethanes, polyurethaneureas, polyolefins, and combinations thereof. Examples of adhesives include at least one hot melt adhesives, reactive polyurethane, cyanoacrylate, epoxy, polyvinyl acetate, plastisol, thermoplastic, silicone, polyurethaneurea aqueous dispersion, and combinations thereof

These films or adhesives are bonded, attached or adhered to fabrics including circular knits, warp knits, wovens, and nonwovens including leather.

This invention encompasses a broad range of fabric combinations including but are not limited warp knit and circular knits, woven fabric, and nonwovens. For example; it maybe advantageous to combine circular knits with warp knits by optimizing the use of the circular knit stretch potential in the warp direction by bonding to the back of the fabric and combining this with warp knit bonded to the face of the fabric to achieve optimum warp stretch while still bonding in the machine direction. Similarly, it maybe advantageous to bond a warp knit to the back of the fabric and combine with a circular knit bonded to the face to optimize weft stretch while still bonding to the back of the fabric.

In other embodiments are the optimized use of a bonded fabric combined with a foam or other substrates. Whenever a bonded fabric is used, this invention offers an improvement in the bonded fabric stretchability.

In bonding, the typical protocol is to bond in a similar construction as with sewing; in other words the side of the fabric worn against the skin would be the surface side bonded to the adhesive. Although, the side of the fabric that is exposed for display is a design decision, there is a technical face of a fabric and a technical back. In a seam or edgeband, typically, the back side of the fabric is bonded by folding over on itself and bonding the adhesive in between the fabric layers. This type of construction bonds the fabric back to back.

Conventional bonding protocol would bond fabrics together considering only the design element, i.e.; which fabric side is displayed in the garment during wear. By considering the fabric construction and stitch movement bonded fabric with stretchability approaching that of the sum of the components can be achieved. In some embodiments are garments including multiple layer materials including at least two fabric layers and at least one layer of adhesive which may be continuous or discontinuous. Discontinuous application such as a dot or strip application may be selected from the group consisting of dots, vertical lines, horizontal lines, diagonal lines, a grid, and combinations thereof. The lines may be either straight, wavy, or zigzag. Examples of fabric include but are not limited to circular knits, warp knits, wovens, nonwovens including leather. Examples of adhesives include but are not limited to polyurethaneurea (PUU), thermoplastic polyurethane, polyamide, polyester, polyolefin. The polyurethaneurea may be in any suitable form including a film, and dispersion and combinations thereof.

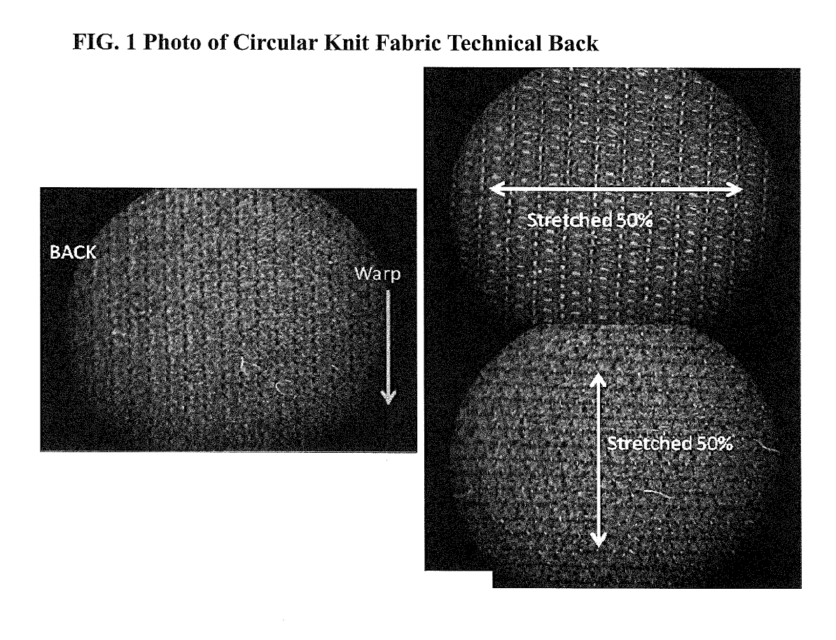

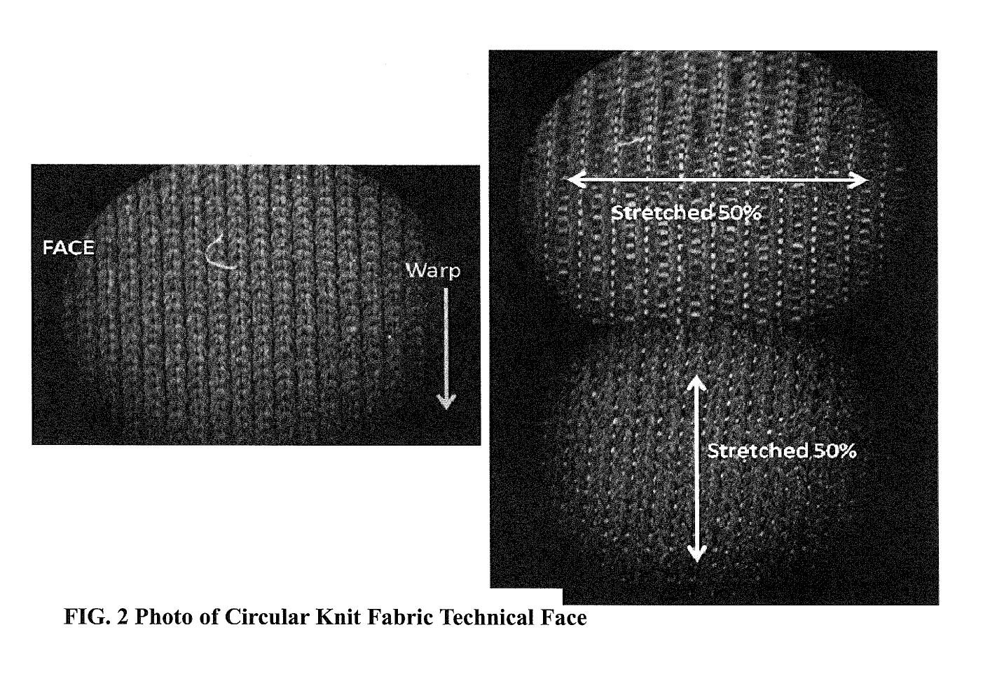

Included is an article including a garment having at bonded fabric that is stretchable and has a modulus comparable to that of the components of the bonded fabric. Several characteristics of the fabric for bonding are important to understand. Stretch fabrics can have two way stretch (warp and weft) or they can be one way stretch (either warp or weft). For two way stretch fabric, the weft and warp direction modulus and stretch potential are often not equal. For many fabrics, characteristics of the face of the fabric are different than that of the back of the fabric; example of an exception would be woven plain weave fabric. By studying the fabric constructions and stitch configuration in the fabric with no extension and comparing it to fabric held under extension the required stitch movement can be understood. As an example; FIG. 1, below depicts the back of circular knit fabric (Jersey Lomellina Spa Circular Knit, Wonder Black Line fabric, PEZZA 00117797, Bango 741032; 80% Polyamide 20% Elastane) shown at rest, 50% weft extension and 50% warp extension. It can be seen that the stitches (yarns) exposed on the back of the fabric required to move when the fabric is stretched in the weft direction. Conversely, the stitches (yarns) exposed on the back of the fabric are not required to move when the fabric is stretched in the warp direction. FIG. 2, below depicts the face of the same circular knit fabric shown at rest, 50% weft extension and 50% warp extension. It can be seen that the stitches (yarns) exposed on the face of the fabric required to move when the fabric is stretched in the warp direction. Conversely, the stitches (yarns) exposed on the face of the fabric are not required to move when the fabric is stretched in the weft direction.

When a fabric is bonded with an adhesive film, the primary mechanism for adhesion is the adhesive material interpenetrating the yarns and filaments comprising the fabric surface being bonded. To prepare a bonded fabric with stretchability, it is desirable to have a bonded fabric in which the fabric including a polymer film adhered to the fabric, where the adhesion between the polymer film and the yarns, in the desired direction of stretch are minimized. By selecting an adhesive with elastic properties the stretchability of the bonded fabric can be enhanced.

In some embodiments of the present invention fabrics that are bonded include a technical face and a technical back where the surface characteristics of the fabrics are different on opposing sides of the fabrics. The terms technical face and technical back are used interchangeably with the terms face and back respectively. For a weft knit fabric, such as a single jersey circular knit fabric, the technical face includes the characteristic wale chain stitch appearance on the face of the fabric. The technical back of the circular knit fabric includes the characteristic top/bottom loop/stick appearance on the back of the fabric. For a warp knit fabric the technical face includes the characteristic warp chain stitch appearance on the face of the fabric and the technical back includes the characteristic cross over loop/stitch on the back of the fabric. For a woven fabric, the technical face primarily includes the warp yarns (such as in a twill fabric).

Table 1, below depicts the six unique combinations of fabric orientation that can be conceived for a 2 dimensional fabric structure orientated 0° and 90° and face/back. In this discussion, 0° the fabric is aligned so the machine direction is vertical; 90° the fabric is aligned so the machine direction is horizontal.

TABLE 1
Six Unique Bonded Fabric Laminate Constructions for a 0/90
fabric orientation and face/back.

| | FACE/0 | FACE/90 | BACK/0 | BACK/90 |
|---|---|---|---|---|
| FACE/0 | F0F0 | F0F90 | F0B0¹ | F0B90² |
| BACK/0 | B0F0¹ | B0F90² | B0B0 | B0B90 |

¹Laminates F0B0 and B0F0 are equivalent
²Laminates B0F90 and F0B90 are equivalent (if F0B90 is rotated 90° and turned over prior to comparison with B0F90)

This invention relates to the optimization of stretch and recovery of bonded fabrics by considering the fabric construction, orientation and direction of desired stretch. It is unexpected that the conventional bonded fabrics are not optimized; in other words if one follows simply retrofits the sewn fabric seam, edgeband or bonded area by inserting a film and bonding between the fabric layers, it does not necessarily result in the optimized bonded laminate construction of the six possible listed above in Table 1. Additional orientations of the fabric (such as angles from about 0° to about 90°) may also result in an acceptable improvement in stretch compared to conventional bonding orientations. What is considered the optimal stretch or an acceptable improvement in stretch will depend on the fabric structure which determines the extent of bonding between the fabric and film.

General guidelines for bonded 2-way stretch CK (circular knit) fabrics with stretchability are;

| CK Bond to: | Weft Stretch | Warp Stretch |
|---|---|---|
| F0F0 | Very Good | Fair |
| F0F90 (balanced stretch) | Fair | Fair |
| B0B0 | Bad | Good |
| B0B90 (balanced stretch) | Bad | Bad |
| F0B0 | Bad | Bad |
| F0B90 | Very Good | Fair |

General guidelines for bonded 2-way stretch WK (warp knit) fabrics with stretchability are:

| WK Bond to: | Weft Stretch | Warp Stretch |
|---|---|---|
| F0F0 | Good | Fair |
| F0F90 (balanced stretch) | Fair | Fair |
| B0B0 | Fair | Very Good |
| B0B90 (balanced stretch) | Good | Good |
| F0B0 | Poor | Poor |
| F0B90 | Very Good | Fair |

General guidelines for bonded 1-way stretch CK and woven stretch fabric with stretchability is bond face to face. For 1-way stretch Warp Knit fabric, with stretchability general guideline is to bond technical back to technical back.

In some embodiments are multiple layer articles which include at least one layer of a polymer composition in the form of a film or dispersion or an adhesive. These articles have at least two layers including at least one adhesive layer comprised of but not limited to a polymer composition or adhesive. The polymer composition or adhesive may form one of the layers, for example, as a polymer composition or adhesive on a substrate. The polymer composition or adhesive may be in any suitable form such as a film or dispersion. The polymer composition or adhesive may be placed adjacent to or between the layers and also may provide stretch and recovery, increased elastic modulus, adhesion, moldability, shape retention, and flexibility properties for the article. These articles may be formed into fabrics and/or garments.

A variety of different polymer compositions or adhesives are useful with the films and dispersions of some embodiments. For example, the films of the some embodiments may be cast from a solution, an aqueous dispersion, or a substantially solvent free aqueous dispersion. Alternatively, the films may be formed by melting and cooling a thermoplastic resin. Many such solutions or dispersions are known in the art. For example, a polyurethaneurea solution such as a spinning solution from a commercial spandex production line may be used to cast a film, according to some embodiments of the present invention. Specific examples of aqueous dispersions and films cast from them which are useful with the present invention are described hereinbelow.

In an embodiment where the article includes a multiple layer article including three or more layers where one layer is a film, the film may be an intermediate layer between two fabric layers, between two foam layers, between a fabric layer and a foam layer, or adjacent to a foam layer which is adjacent to a fabric layer. Combinations of these fabric/foam/film arrangements are also contemplated. For example, the article may include, in order, a fabric layer, a foam layer, a film layer, a foam layer, and a fabric layer. The film layer may be any to suitable polymer as described above including, but not limited to a polyurethaneurea composition, a thermoplastic polyurethane (TPU), a polyolefin, etc. This article includes two separate fabric layers, two separate foam layers and a film layer. In any of these embodiments, the polyurethaneurea film may be replaced with a polyurethaneurea dispersion. Therefore, the article may include one or more polyurethaneurea film and one or more polyurethaneurea dispersion layer.

The first substrate and the second substrate are independently chosen from foam, fabric or any other suitable substrate.

In an embodiment that includes two or more layers, the polymer composition or adhesive may form the external layer. Including the polymer composition or adhesive on an external surface forms many advantageous functions. For example, the polymer composition or adhesive may provide an anchor or area of increased friction to reduce the relative movement between the article including the polymer composition or adhesive and an external substrate. This is particularly useful when the article is an undergarment including a skin-contacting surface (where the wearer's skin is the substrate). Alternatively, the substrate may be outer clothing which is in contact with the polymer composition or adhesive of the inventive article. Where the substrate is outer clothing of a wearer and the article is worn as an undergarment, the article prevents or reduces the relative movement of the outer garment. In addition, an outer garment (e.g. a dress) may include a polymer composition or adhesive to maintain the relative placement of an inner garment (e.g. a slip).

After the layers of fabric, foam, and the polyurethaneurea composition have been selected, they may subsequently be adhered through pressing or molding to form flat or shaped articles. The processes to prepare the pressed and molded articles of some embodiments include the use of pressure and heat as necessary. For example, heat may be applied at about 150° C. to about 200° C. or about 180° C. to about 190° C., including about 185° C. for a sufficient time to achieve a molded article. Suitable times for application of heat include, but are not limited to, from about 30 sec to about 360 sec including from about 45 sec to about 120 sec. Bonding may be effected by any known method, including but not limited to, microwave, infrared, conduction, ultrasonic, pressure application over time (i.e. clamping) and combinations thereof.

Due the application of heat and pressure to the articles including polymer composition or adhesive or dispersion and given that films and fabrics are themselves porous materials, it is recognized that the film or dispersion may partially or completely impregnate the fabric or foam of the article. For example, the polyurethaneurea composition may form a layer which is partially separate from the surrounding layers, or may be completely transferred to the surrounding layer or layers to form an integrated article without a distinguishably separate polyurethaneurea composition layer.

One application of the multi-layer articles of the present invention is body-shaping garments such as brassieres (especially in cups or wings) and men's undergarments. These articles can provide the desirable features of comfort, body shaping and support while still providing comfort, breathability, air permeability, moisture/vapor transport, wicking, and combinations thereof. In the articles of some embodiments of the present invention, the layers may take on predetermined shapes and may be arranged in predetermined orientations relative to each other in the design of a molded or shaped article such as the cups of a brassiere construction. The layers of these fabrics may be used either alone or in combination with other materials that are sewn, glued or otherwise applied to the fabrics.

In some embodiments there is a system for the construction of a body-shaping garment with integrated shaping ability provided by the fabric. This system of construction may be used in a variety of different garment constructions such as activewear, sportswear, men's and women's intimate apparel such as bras, underwear, panties, shaping garments, legwear and hosiery such as pantyhose, ready-to-wear garments such as denim jeans, camisoles, tailored shirts, and pants among others. This construction may be applied to any formable body area. While many advantages of the fabric constructions are included, it is further recognized that the utility is not limited to garments, but also finds applicability with any shapeable or formable medium, including cushions for furniture which are also subject to movement and potential slipping of a fabric in contact with the shapeable area.

In order to add additional support and other features, the polymer composition or adhesive may be added to different areas of the article. For example, when a film is used, it may either extend through the entire area of the article or to a selected portion to provide different benefits. For example, a brassiere may include a layered fabric of some embodiments in the cup portion. In the brassiere cup, it can be useful to use a portion of film in the lower portion of the cup for support, in a central portion of the cup for modesty, in the side portion for shaping, or in specific areas for embellishment or decoration.

Reducing the amount of film in a multi-layer fabric to meet the needs of a fabric may also increase the air permeability of the fabric. As is shown in the examples, the polyurethaneurea compositions derived from the aqueous dispersion described herein provided greater air permeability than those derived from polyurethaneurea solutions. The films cast from the aqueous dispersions also performed better with respect to air permeability in comparison to commercially available thermoplastic polyurethane (TPU) films available from Bemis. Air permeability may also be increased by altering the film to make it porous or to become porous (i.e. “latent” breathability) or by perforating the film.

Another advantage of the films cast from the aqueous dispersions of some embodiments is with respect to the feel or tactility of the films. They provide a softer feel compared to silicone rubber or the commercially available TPU films while maintaining the desired friction to reduce movement that is a further advantage for skin contact applications. Also lower bending modulus gives better drape and fabric hand.

The polyurethaneurea compositions provide additional benefits especially as compared to commercially available thermoplastic polyurethaneurea compositions, when used in a garment. These benefits include shape retention, shaping ability, adhesion, maintaining a fraction of the substrates, moisture management, and vapor permeability.

The polyurethaneurea compositions may be added in other constructions depending on the desired function which may be a visual aesthetic. The polyurethaneurea films or dispersions may be added to an article, fabric or garment to be molded into a design, to adhere embellishments such as decorative fabrics and glitter, in the form of a label or logo, and combinations thereof. Such polyurethaneurea films are commercially available from INVISTA.

Depending on the desired effect of the polyurethaneurea composition when applied as a film or dispersion from the aqueous dispersion described herein, the weight average molecular weight of the polymer in the film may vary from about 40,000 to about 150,000, including from about 100,000 to about 150,000 and about 120,000 to about 140,000.

In some embodiments, the polymer composition or adhesive may act as an adhesive to attach two or more layers of fabric or foam, or to attach a layer of fabric to foam. One suitable method for accomplishing this is to apply a dispersion to a layer by any suitable method. Methods for applying the dispersions of some embodiments include spraying, kissing, printing, brushing, dipping, padding, dispensing, metering, painting, and combinations thereof. This may be followed by application of heat and/or pressure.

Other adhesives may be included in the multiple layer articles of some embodiments of the invention either alone or in combination with a polymer composition or film. Examples of adhesives include thermoset or thermoplastic adhesives, pressure sensitive adhesives, hot melt adhesives, and combinations thereof. The adhesive may be used to adhere the different layers and may be applied to any of the fabric, foam or polyurethaneurea films or dispersion. Moreover, the polyurethaneurea aqueous dispersions may also be used as an adhesive to adhere more than one layer of any fabric, foam or polyurethaneurea film as described in some embodiments.

As described above, there are a variety of fabric constructions that are useful for the articles of the present invention. Furthermore, the polyurethane composition may be either a film or a dispersion in any of these embodiments. In addition, the polymer composition or adhesive may provide structural properties, flexibility, adhesion, or any combination of these. The order of layer arrangement may be (1) fabric layer, foam layer, polyurethaneurea composition layer; (2) fabric layer, foam layer, polyurethaneurea composition layer, foam layer, fabric layer; (3) fabric layer, polyurethaneurea composition layer, fabric layer; (4) foam layer, polyurethaneurea layer, foam layer; (5) foam layer, polyurethaneurea composition layer; (6) fabric layer, polyurethaneurea layer; or any combination of these which may be combined to achieve more layers in the fabric construction. An adhesive may be included to adhere any of the layers, including wherein the polyurethaneurea composition is the adhesive.

A variety of different fibers and yarns may be used with the fabrics of some embodiments. These include cotton, wool, acrylic, polyamide (nylon), polyester (also including multiple component polyester fiber such as elasterell-p available under the trade name LYCRA®T400® fiber from INVISTA S.àr.l. of Wichita, Kans.), spandex, regenerated cellulose, rubber (natural or synthetic), bamboo, silk, soy or combinations thereof.

Aqueous polyurethane dispersions useful in some embodiments of the invention are provided from particular urethane prepolymers, which are described below in more detail.

Urethane prepolymers, or capped glycols, can generally be conceptualized as the reaction product of a polyol, a polyisocyanate, and a compound capable of salt-forming upon neutralization, before the prepolymer is dispersed in water and is chain-extended. Such prepolymers can typically be made in one or more steps, with or without solvents. Depending on whether the prepolymer is dissolved in a less volatile solvent (such as MEK, or NMP) which will remain in the dispersion; dissolved in a volatile solvent such as acetone, which can be later removed; or is dispersed in water without any solvent; the dispersion process can be classified in practice as the solvent process, acetone process, or prepolymer mixing process. The prepolymer mixing process has environmental and economical advantages, and therefore is also useful as the basic process for making the aqueous dispersions in the present invention.

How the fabric layers can be bonded to maximize stretch, by minimizing yarn contact in the fabric in the direction of stretch depends on the fabric construction. Where the yarn structures that stretch in the selected direction of stretch are primarily on the technical face of the first substrate and the elastic component may be adhered to the technical back of the first substrate. Examples include:

Where the yarn structures that stretch in the selected direction of stretch are primarily on the technical back of the first substrate and the elastic component is adhered to the technical face of said first substrate;

Where the yarn structures that stretch in the selected direction of stretch are primarily on the technical face of the first substrate and the elastic component may be adhered to the technical back of said first substrate;

Where said first substrate and said second substrate each include a fabric;
each fabric includes a warp direction and a weft direction;
and may be bonded with orientation of about 0° to about 15°, including about 0° to about 5° or about 0° or an orientation of about 75° to about 90°, including about 85° to about 90° or about 90°.

Where the second substrate is a woven fabric, a warp knit fabric, or a weft knit fabric and the elastic component is bonded to the technical face of each of the first substrate and the second substrate with an orientation of about 0° to about 15°, including about 0° to about 5° or about 0°.

Where the second substrate is a woven fabric, a warp knit fabric, or a weft knit fabric and the elastic component is bonded to the technical back of each of the first substrate and the second substrate with an orientation of about 0° to about 15°, including about 0° to about 5° or about 0°.

Where the second substrate is a woven fabric, a warp knit fabric, or a weft knit fabric and the elastic component is bonded to the technical face of each of the first substrate and the second substrate with an orientation of about 75° to about 90°, including about 85° to about 90° or about 90°.

Where the second substrate is a woven fabric, a warp knit fabric, or a weft knit fabric and the elastic component is bonded to the technical face of the first substrate and the technical back of the second substrate with an orientation of about 75° to about 90°, including about 85° to about 90° or about 90°.

The features and advantages of the present invention are more fully shown by the following examples which are provided for purposes of illustration, and are not to be construed as limiting the invention in any way.

### EXAMPLE 1

Using a circular knit Jersey Lomellina Spa Circular Knit, Wonder Black Line fabric, PEZZA 00117797, Bango 741032; 80% Polyamide 20% Elastane and INVISTA film Type T070 were used to prepare a fabric film fabric laminate in each of the six unique constructions described in Table 1. The fabric technical face and back is seen in FIGS. 1 and 2.

These samples were pressed using a MACPI Press, Model #553. 37-9124.00 manufactured by Macpi Group 170° C. for 30 seconds at a pressure of approximately 72 psi or 5 bar. Table 2 summarizes the first load force in grams for a 1 inch laminate strip at various elongation for the materials prepared and their components. The laminates were tested in both weft and warp direction. For this circular knit fabric tested, hand stretch was found to be ˜90% in weft direction and ˜70% in warp direction. From Table 1, it can be seen that the force to extend the bonded laminate is dramatically decreased by bonding F0F0 vs. B0B0. Lower force at a given elongation is indicative of greater stretch potential; stretchability. Therefore, the bonded fabrics laminated F0F0 and F0B90 offer the best stretchability in the weft direction for this circular knit fabric. Considering the warp direction stretch, it can be seen that B0B0and F0B90 are the preferred constructions for a stretchable bonded fabric with this circular knit fabric.

TABLE 2
First load force (g) vs. Strain for various fabric orientation and
components - % increase in Modulus

| | 0 | 10 | 20 | 30 | 40 | 50 |
|---|---|---|---|---|---|---|
| Weft Elongation, % | | | | | | |
| B0B0 | 0 | 1569 | 2452 | 2999 | 3362 | 3630 |
| F0F0 | 0 | 536 | 902 | 1206 | 1482 | 1760 |
| F0B0 | 0 | 1389 | 2160 | 2647 | 3008 | 3319 |
| B0B90 | 0 | 1376 | 2146 | 2632 | 2992 | 3302 |
| F0F90 | 0 | 824 | 1344 | 1745 | 2093 | 2424 |
| F0B90 | 0 | 540 | 894 | 1185 | 1454 | 1721 |
| 2 layers fabric | 0 | 107 | 197 | 297 | 399 | 499 |
| T070 film | 0 | 329 | 511 | 626 | 718 | 795 |
| Not Bonded, | 0 | 451 | 745 | 980 | 1180 | 1359 |
| Film/Fabric/Film | | | | | | |
| Warp Elongation, % | | | | | | |
| F0F0 | 0 | 993 | 1604 | 2029 | 2357 | 2644 |
| B0B0 | 0 | 639 | 1049 | 1383 | 1696 | 2018 |
| F0B90 | 0 | 1104 | 1748 | 2179 | 2491 | 2743 |
| 2 layers fabric | 0 | 114 | 215 | 330 | 456 | 590 |
| T070 film | 0 | 329 | 511 | 626 | 718 | 795 |

Since the maximum stretchability and the lowest possible value for force response is the case of the components (fabric, film, fabric) alone with no bonding, however for a bonded fabric to have utility it must have a durable bond. An example of durable bonded fabric is that which has excellent retention of peel strength after 50 launderings, or survives an accelerated wash test such as Dura Wash. In Table 3, the data is shown as a % increase over the force of the components alone.

TABLE 3
Percent increase of first load force (g) vs. Strain as compared to that of
the sum of the components for various fabric orientation and components

| | 0 | 10 | 20 | 30 | 40 | 50 |
|---|---|---|---|---|---|---|
| Weft Elongation, % | | | | | | |
| B0B0 | 0 | 260 | 246 | 225 | 201 | 181 |
| F0F0 | 0 | 23 | 27 | 31 | 33 | 36 |
| F0B0 | 0 | 219 | 205 | 187 | 169 | 156 |
| B0B90 | 0 | 213 | 199 | 180 | 161 | 146 |
| F0F90 | 0 | 87 | 87 | 86 | 83 | 81 |
| F0B90 | 0 | 23 | 25 | 26 | 27 | 28 |
| Warp Elongation, % | | | | | | |
| F0F0 | 0 | 124 | 121 | 112 | 101 | 91 |
| B0B0 | 0 | 44 | 44 | 45 | 44 | 46 |
| F0B90 | 0 | 151 | 144 | 132 | 117 | 105 |

Considering the % increase in force for the bonded fabric as compared to the unbonded or not bonded components, it can be seen that for weft stretch, F0F0 and F0B90 are best for stretchable bonded fabrics and conversely for warp stretch B0B0 is optimum. If it is desired to have balanced stretch in warp and weft, then the F0F90 is the preferred bonded fabric construction. Balanced stretch refers to a more evenly distributed fabric.

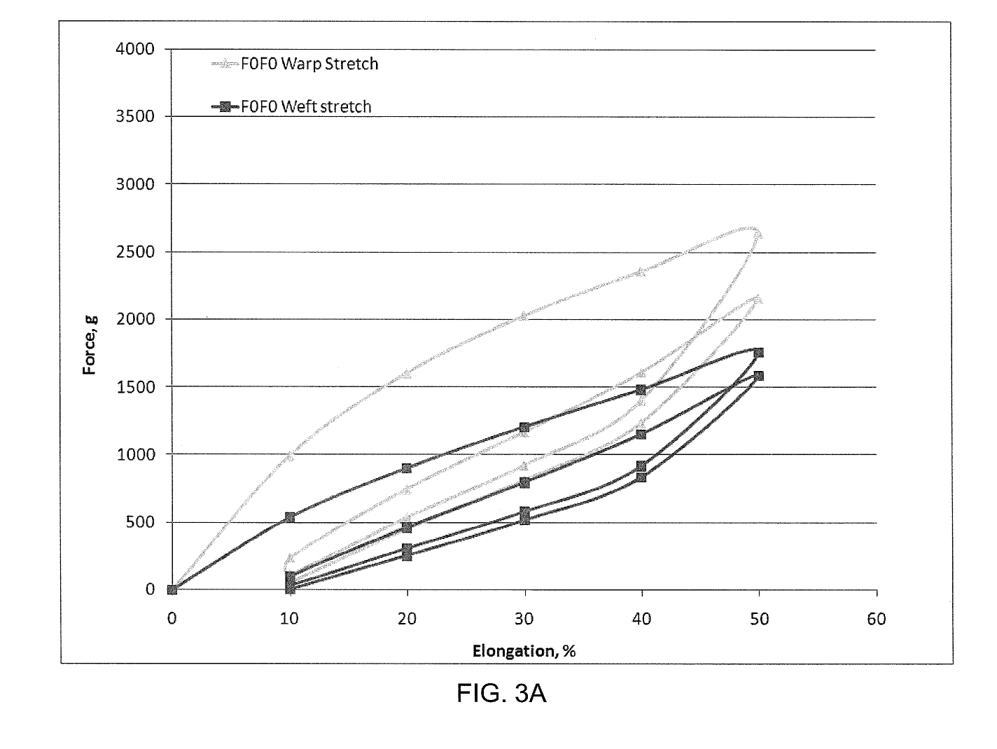

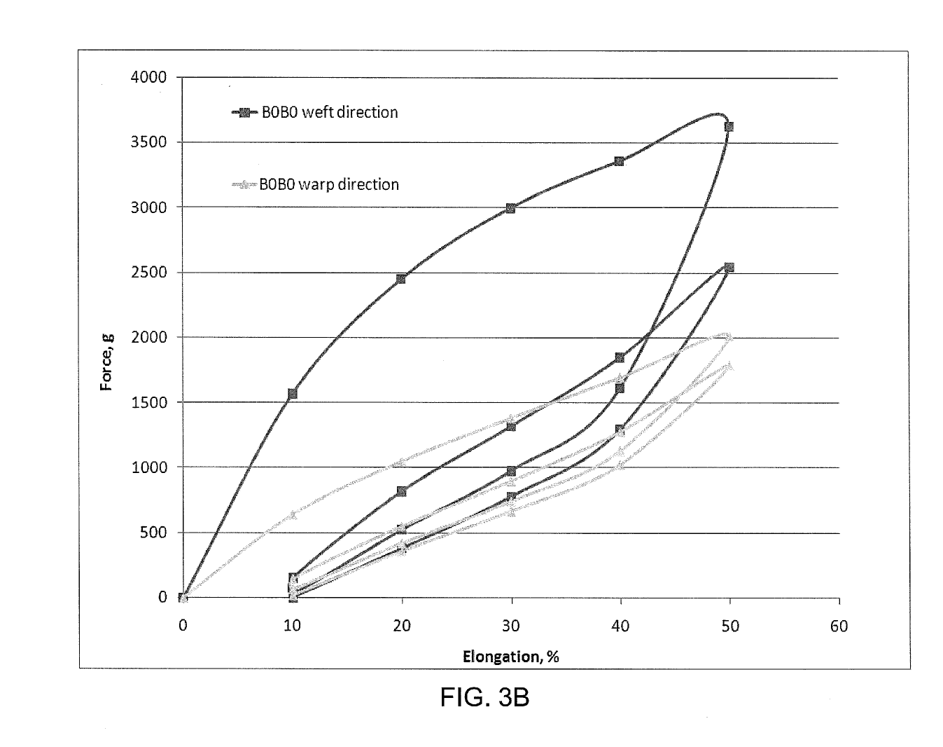

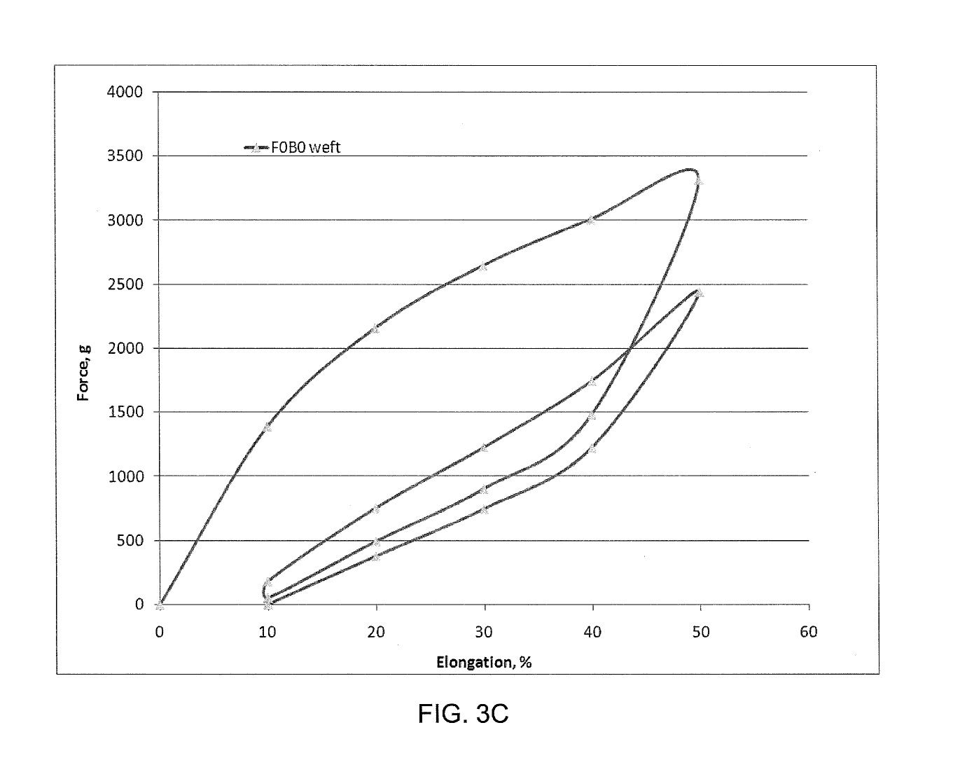

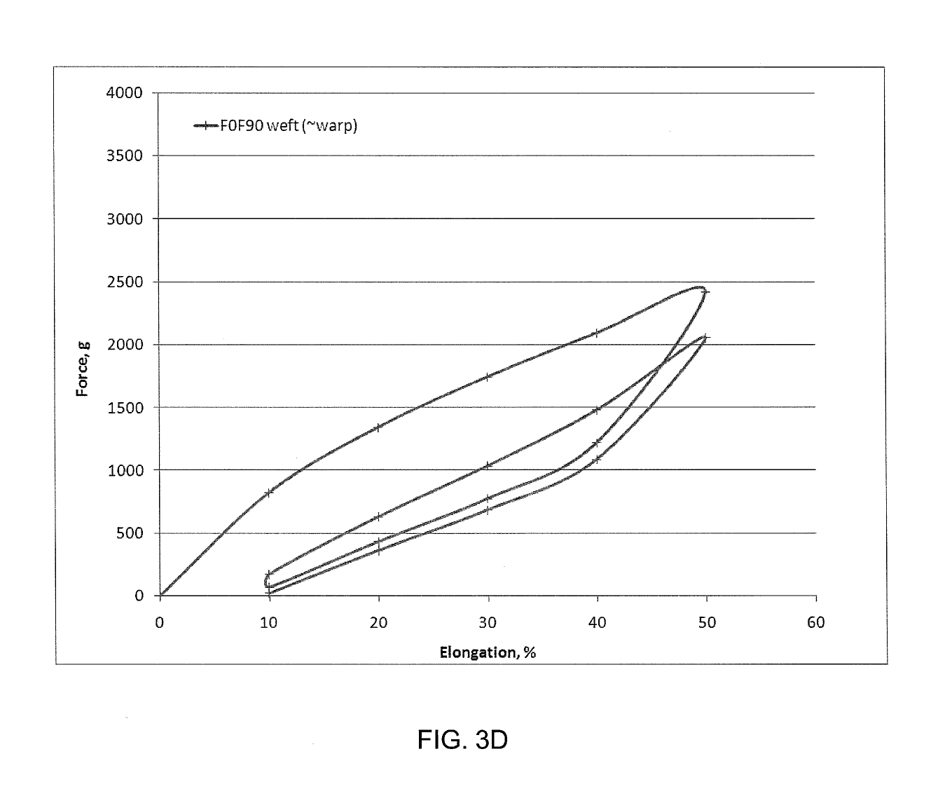

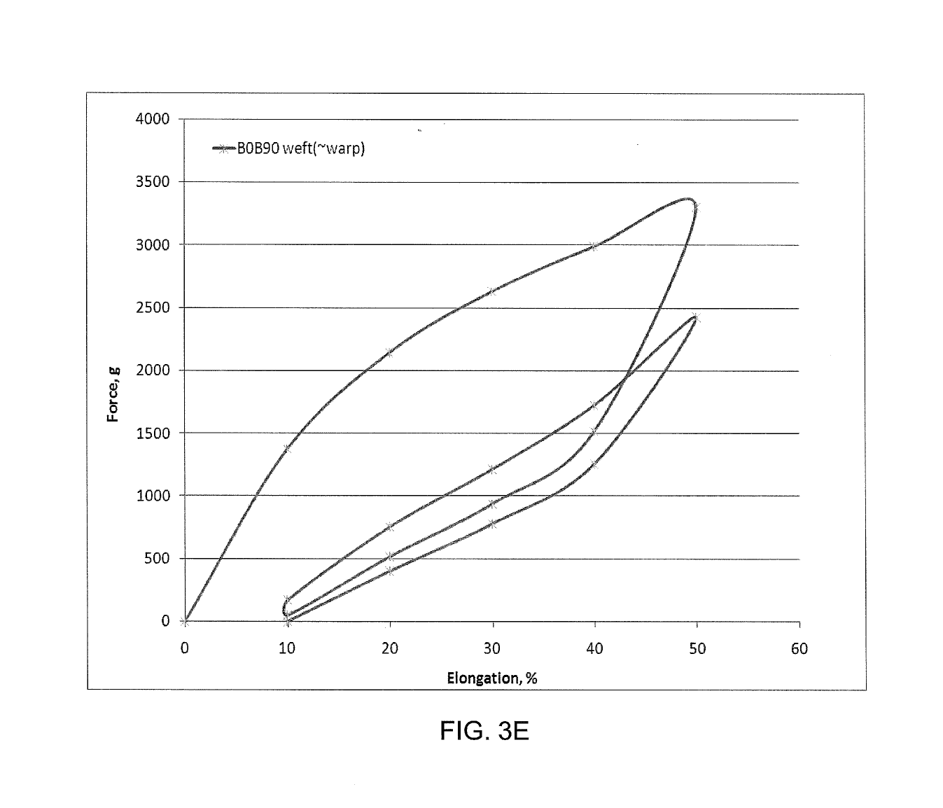

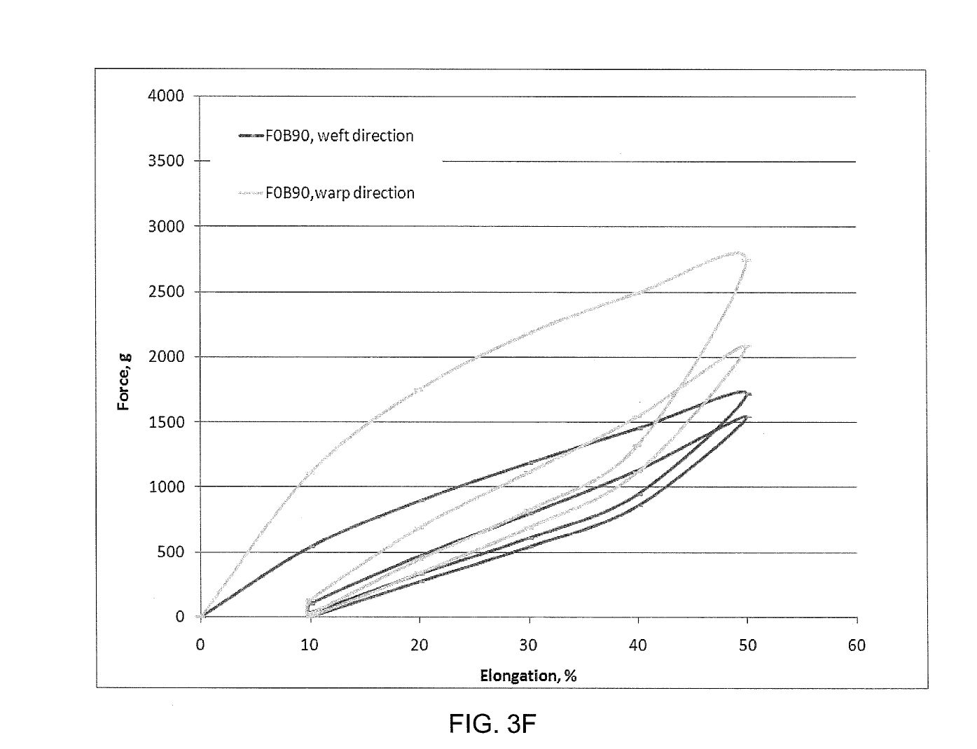

For stretch materials the mechanical behavior can be characterized by cycling of the material to a fixed elongation. In FIG. 3, the stress/strain response for the various laminates from Table 1 are shown. The response is shown for the first cycle and the third cycle testing to 50% elongation. The top-line of each curve represents the force required to stretch or elongate the bonded fabric (i.e., the load force). The bottom line of the each curve represents the recovery (i.e., the unload force) the bonded fabric exerts at a given elongation. The unload force is always lower than the load force because of the phenomenon known as “stress decay”. The area inside the stress/strain curve is the hysteresis. The larger the difference between the load and the unload forces, the greater the hysteresis. Is it desirable to have lower hysteresis since this is characteristic of the material having shape retention and recovery power. Additionally, it is desirable to have a relatively flat stress/strain behavior. A flatter curve is characteristic of minimal change in force during extension of material, which is indicative of comfort during wear.

FIG. 3 Stress(force)/Strain curves for bonded fabric constructions (F0F0 (FIG. 3A), B0B0 (FIG. 3B), F0B0 (FIG. 3C), F0F90(FIG. 3D), B0B90(FIG. 3E), F0B90(FIG. 3F)) cycled to 50% elongation, first and third cycle is depicted. Bonded fabrics were tested in the weft and warp direction.

Looking at the shape of the curves in FIGS. 3A-3F, it can be seen that the F0F0 and the F0B90 samples offer excellent stretch potential and low hysteresis. A bonded fabric with balance stretch with the best stretch potential and hysteresis can be achieved with construction F0F90. It is also noted that the fabric handle, drape is improved for the F0F0 laminate as compared to the B0B0.

### EXAMPLE 2

The components do contribute to the relative performance, to demonstrate the effect of adhesive film choice, an example using Bemis 3415 (Bemis Associates Shirley, Mass.). Using a circular knit Jersey Lomellina Spa Circular Knit, Wonder Black Line fabric, PEZZA 00117797, Bango 741032; 80% Polyamide 20% Elastane and INVISTA film Type T070 were used to prepare a fabric film fabric laminate in F0F0 and B0B0 constructions described in Table 1. These samples were pressed using a MACPI Press, Model #553. 37-9124.00 manufactured by Macpi Group 160° C. for 30 seconds at a pressure of approximately 72 psi or 5 bar. Table 4 summarizes the first load force in grams for a 1 inch laminate strip at various elongation for the materials prepared and their components. The laminates were tested in both weft and warp direction. It can be seen that by bonding the fabric face to face (F0F0) a bonded fabric with stretchability in the weft direction is produced as compared to weft stretch when the fabric is bonded back to back.

TABLE 4
First load force (g) vs. Strain Bemis3415 compared to INVISTA T070 for
F0F0 and B0B0 construction

| Weft Elongation, % | 0 | 10 | 20 | 30 | 40 | 50 |
|---|---|---|---|---|---|---|
| B0B0 (Bemis 3415) | 0 | 1892 | 2280 | 2580 | 2879 | 3174 |
| B0B0 (INVISTA T070) | 0 | 1569 | 2452 | 2999 | 3362 | 3630 |
| F0F0 (Bemis 3415) | 0 | 859 | 1249 | 1580 | 1893 | 2200 |
| F0F0 (INVISTA T070) | 0 | 536 | 902 | 1206 | 1482 | 1760 |

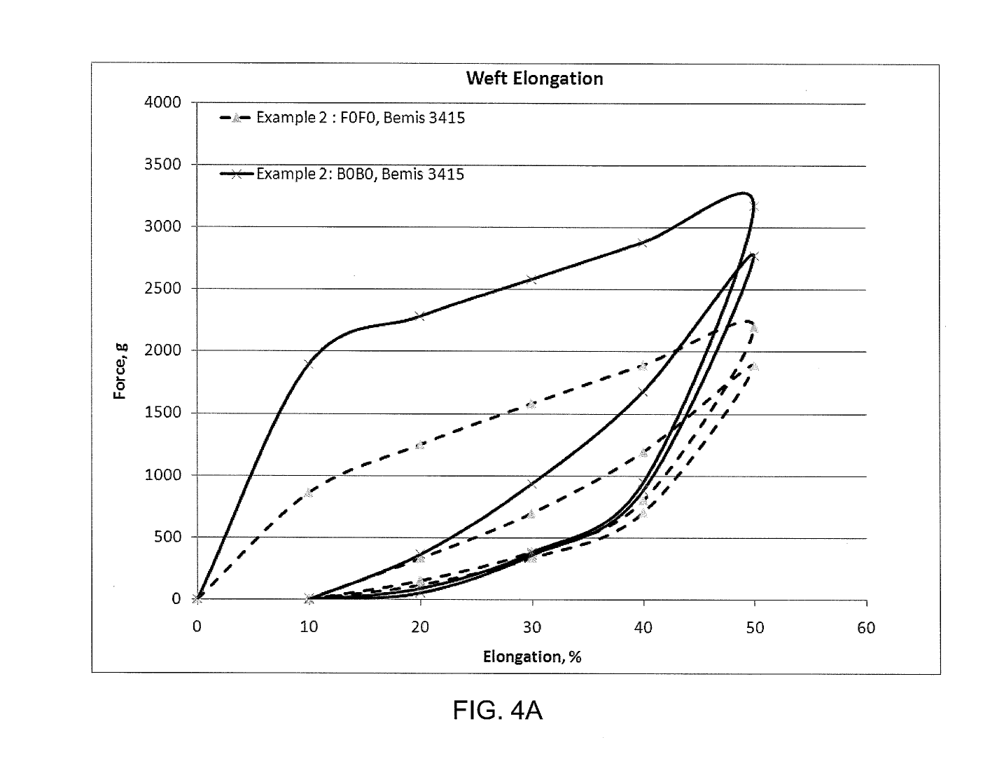

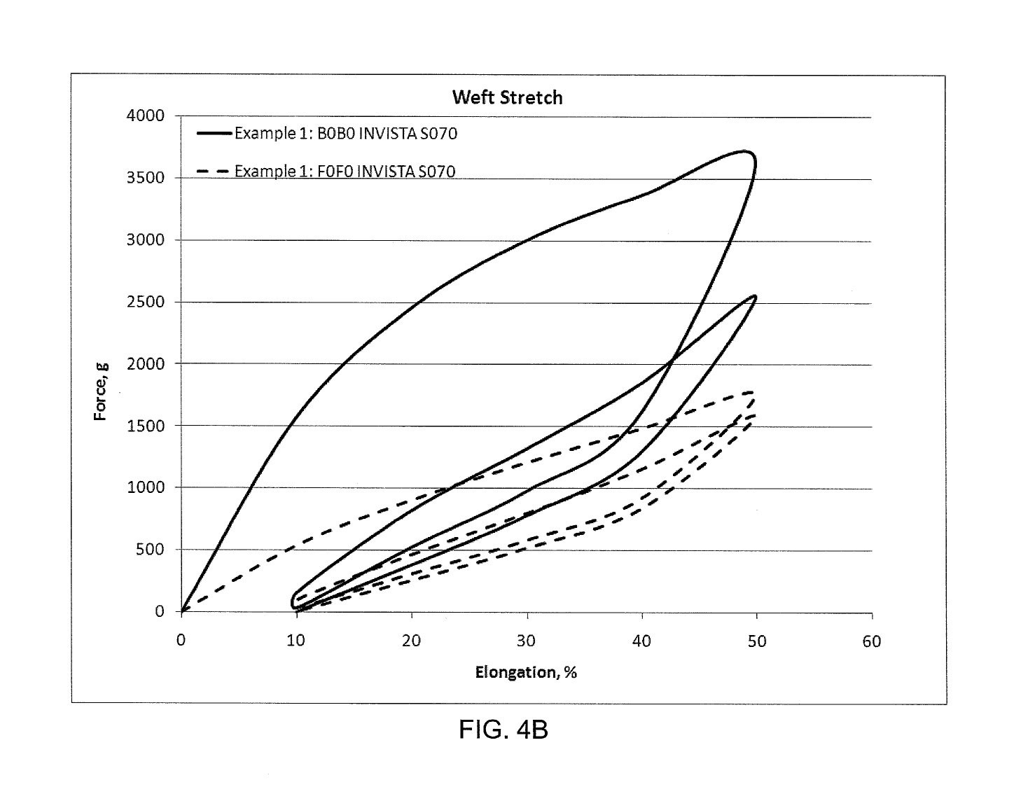

FIGS. 4A and 4B depicts the force (g) vs. weft elongation for a 1″ strip of bonded fabric of this example is compared to that of Example 1. It can be seen that the shape of the curve is effected by the adhesive choice. For example, in FIG. 4B, INVISTA T070 tape as compared to the Bemis 3415 (FIG. 4A) exhibits lower hysteresis. Clearly the adhesive film plays a role in the bonded fabric stretchability and characteristics, but the fabric construction that optimizes stretchability is the same. It is also noted that the fabric handle, drape is improved for the F0F0 laminate as compared to the B0B0.

FIGS. 4A and 4B Stress(force for a 1″ wide strip)/Strain curves for bonded fabric constructions, F0F0, B0B0, cycled to 50% elongation, first and third cycle is depicted for Example 1 and Example 2 bonded fabrics. Bonded fabrics were tested in the weft direction.

### EXAMPLE 3

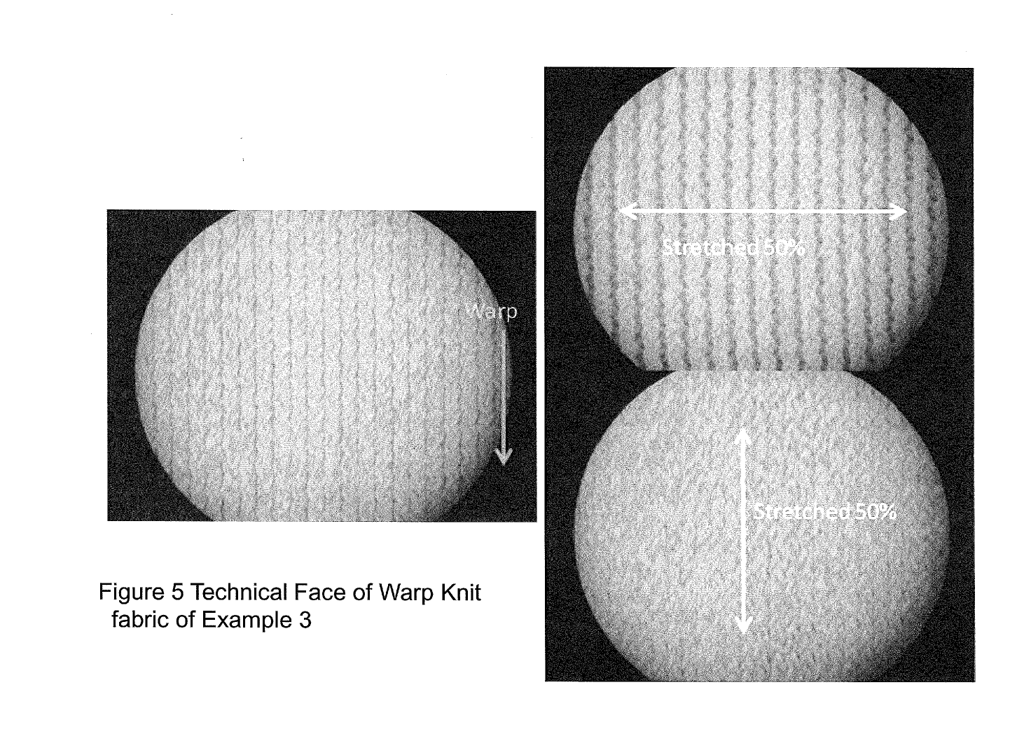

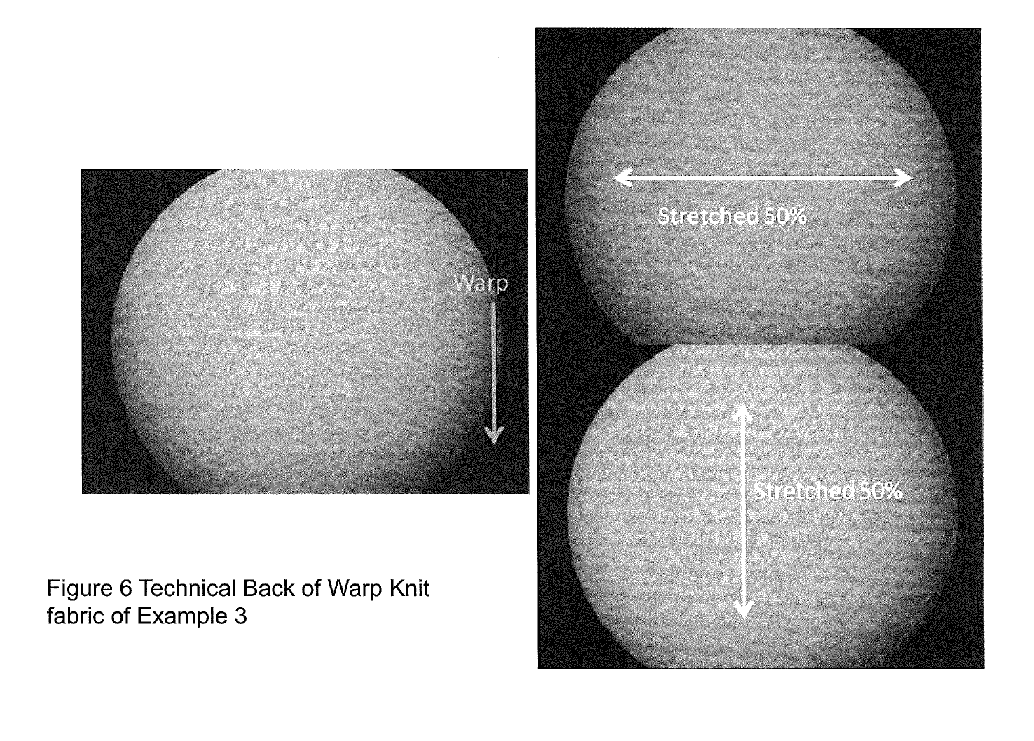

Using a warp knit fabric, Ruey Tay Warp Knit fabric, Polyamide/spandex, item 24105-2NS, white; F970711671, 970721, B1493 and INVISTA film Type T070 were used to prepare a fabric film fabric laminate in F0F0 and B0B0 constructions described in Table 1. The fabric technical face and back are shown in FIGS. 5 and 6. This fabric is shown in the Photos below.

FIG. 5 Technical Face of Warp Knit fabric of Example 3

FIG. 6 Technical Back of Warp Knit fabric of Example 3

These samples were pressed using a MACPI Press, Model #553. 37-9124.00 manufactured by Macpi Group 170° C. for 30 seconds at a pressure of approximately 72 psi or 5 bar. Table 5 summarizes the first load force in grams for a 1 inch laminate strip at various elongation for the materials prepared and their components. The laminates were tested in warp direction. It can be seen that the force for the F0F0 sample can be 50% greater than that of the B0B0 sample.

TABLE 5
First load force (g) vs. warp elongation Example 3 for F0F0 and
B0B0 construction

| Warp Elongation, % | 0 | 10 | 20 | 30 | 40 | 50 |
|---|---|---|---|---|---|---|
| B0B0 | 0 | 448 | 725 | 930 | 1101 | 1256 |
| F0F0 | 0 | 658 | 1120 | 1482 | 1776 | 2021 |
| 2 layers fabric | 0 | 80 | 135 | 192 | 252 | 316 |
| T070 film | 0 | 329 | 511 | 626 | 718 | 795 |

Since the maximum stretchability and the lowest possible value for force response is the case of the components (fabric, film, fabric) alone with no bonding, however for a bonded fabric to have utility it must have a durable bond. An example of durable bonded fabric is that which has excellent retention of peel strength after 50 launderings, or survives an accelerated wash test such as Dura Wash. In Table 6, the data is shown as a % increase over the force of the components alone.

TABLE 6
Percent increase in modulus for bonded fabric vs. un-bonded
components for Example 3

| Warp Elongation, % | 0 | 10 | 20 | 30 | 40 | 50 |
|---|---|---|---|---|---|---|
| B0B0 | 0 | 10 | 12 | 14 | 14 | 13 |
| F0F0 | 0 | 61 | 73 | 81 | 83 | 82 |
| Sum of 2 layers, 0 + T070 film | 0 | 409 | 646 | 818 | 970 | 1111 |

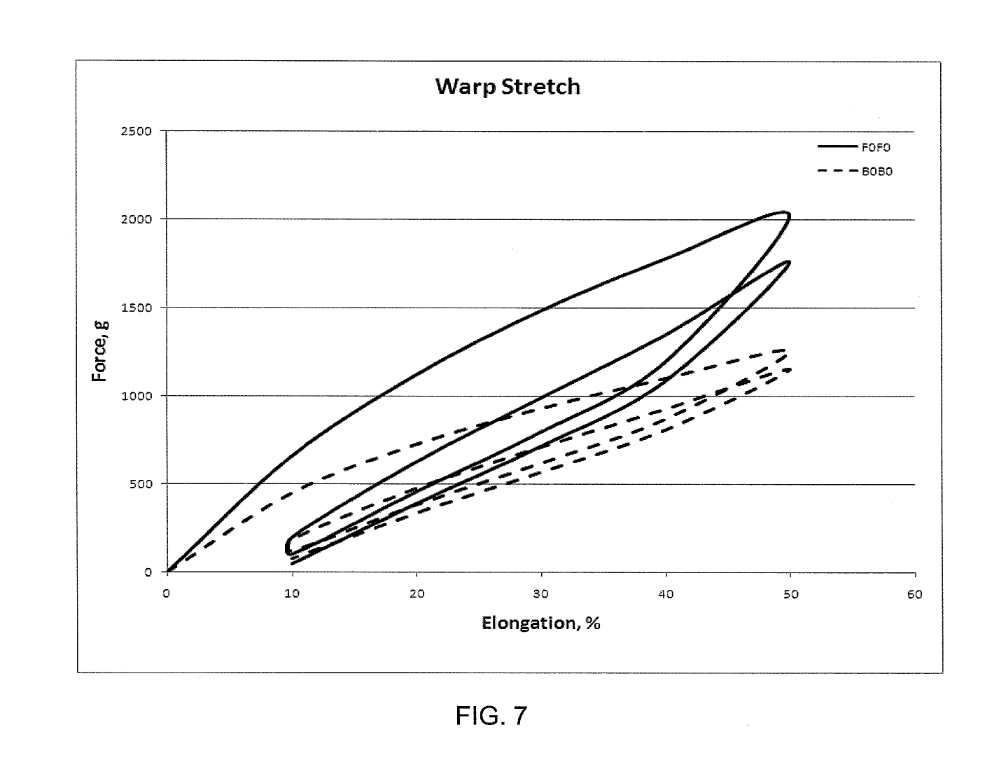

It can be seen that B0B0 nearly approximates the load curve and stretch potential of the unbonded components, showing a 10-15% increase! In FIG. 7, the force for 1 inch strip of bonded fabric of this example is cycled to 50% warp elongation (depicted is the first cycle and the third cycle). Both bonded fabrics offer reasonable stretch potential and good hysteresis. The B0B0 has a very flat curve with depicting its high strechability (stretch potential), excellent hysteresis and recovery. It is also noted that the fabric handle, drape is improved for the F0F0 laminate as compared to the B0B0.

FIG. 7 Stress(force for a 1″ wide strip)/Strain curves for bonded fabric constructions (F0F0, B0B0, cycled to 50% warp elongation, first and third cycle is depicted.

### EXAMPLE 4

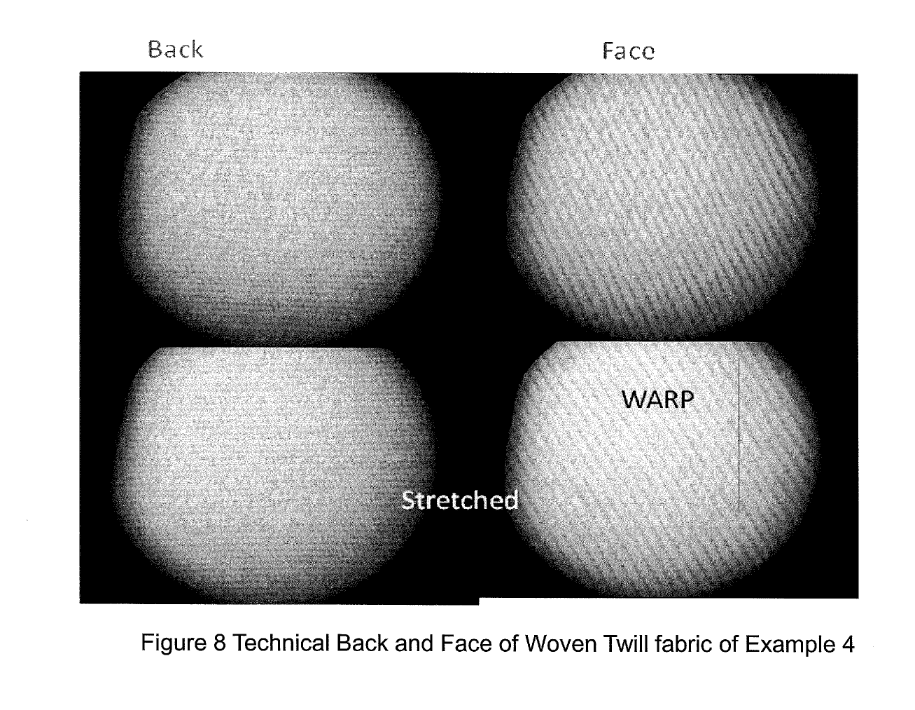

Using a bottom weight 98/2 cotton/spandex twill fabric to prepare a fabric film fabric laminate in F0F0 and B0B0 constructions described in Table 1. The fabric technical face and back are shown in FIG. 8. These samples were pressed using a MACPI Press, Model #553. 37-9124.00 manufactured by Macpi Group 170° C. for 30 seconds at a pressure of approximately 72 psi or 5 bar.

FIG. 8 Technical Back and Face of Woven Twill fabric of Example 4

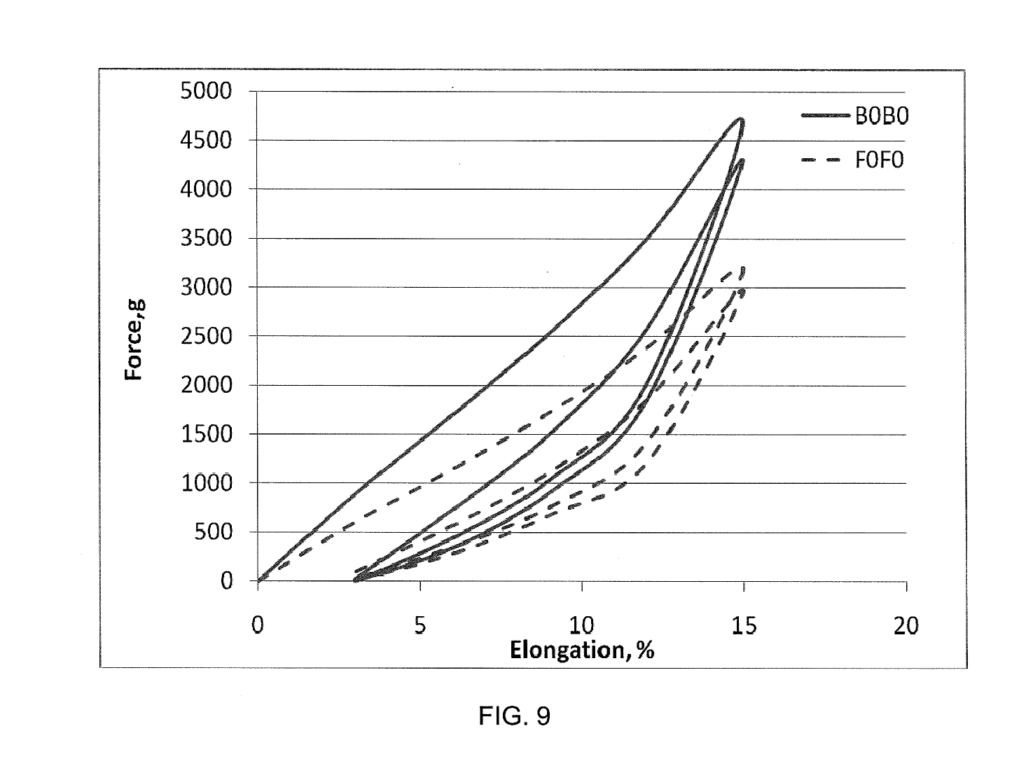

The laminated fabric was cut into 1″ strips and cycled to 15% elongation to quantify the stretch potential and the mechanical characteristics of the bonded fabrics. It can be seen from FIG. 9 that the fabric bonded to the fabric back has higher force than the fabric bonded to the face. This fabric has the stretch yarn in the filling direction which are primarily on the back of the fabric, by bonding to the stretch yarn the bonded fabric stretch ability is reduced. From FIG. 9, the improved strechability and hysteresis and recovery of F0F0 laminate is seen vs. B0B0. It is also noted that the fabric handle, drape is improved for the F0F0 laminate as compared to the B0B0.

FIG. 9 Stress(force for a 1″ wide strip)/Strain curves for bonded woven fabric constructions F0F0 and B0B0, from Example 4, cycled to 15% weft elongation, first and third cycle is depicted.

While the present invention has been described in an illustrative manner, it should be understood that the terminology used is intended to be in a nature of words or description rather than of limitation. Furthermore, while the present invention has been described in terms of several illustrative embodiments, it is to be appreciated that those skilled in the art will readily apply these teachings to other possible variations of the invention.

What is claimed is:

1. An article comprising a first substrate, a second substrate and a bonding component between said first substrate and said second substrate;
wherein said bonding component is selected from the group consisting of an elastomeric polymer film, an adhesive, and combinations thereof;
at least one of said first substrate and said second substrate includes a fabric layer;
said first substrate and said second substrate together include a selected direction of stretch selected from the warp direction, the weft direction, and combinations thereof;
at least one of said first substrate and said second substrate independently include stretchable yarn structures that stretch in a direction selected form the group consisting of the warp direction, the weft direction, and combinations thereof;
said elastic component is adhered to said first substrate and said second substrate to form bonds; and
said bonds between the elastic component and yarns in selected direction of stretch are minimized.

2. The article of claim 1, wherein said bonding component is an elastomeric film selected from the group consisting of polyurethanes, polyurethaneureas, polyolefins, and combinations thereof.

3. The article of claim 1, wherein said first substrate is a fabric selected from the group consisting of a woven fabric, a warp knit fabric, a weft knit fabric, and a nonwoven fabric and said second substrate is selected from the group consisting of a foam, a nonwoven fabric, a woven fabric, a warp knit fabric and a weft knit fabric.

4. The article of claim 1, wherein the adhesive comprises a discontinuous application.

5. The article of claim 4, wherein said discontinuous application is selected from the group consisting of dots, vertical lines, horizontal lines, diagonal lines, wavy lines, zigzag lines, a grid, and combinations thereof.

6. The article of claim 1 wherein said bonding component comprises an adhesive selected from the group consisting of polyurethaneureas, thermoplastic polyurethanes, polyamides, polyolefins, polyesters, hot melt polyesters, polyamides, and combinations thereof.

7. The article of claim 1, having a modulus equal to or less than 1.25 times the sum of the modulus of the first substrate, the bonding component and the second substrate in the absence of adhesion or bonding.

8. The article of claim 1 having modulus equal to or less than the 1.5 times the sum of the modulus of the first substrate, the elastic component and the second substrate in the absence of adhesion or bonding.

9. The article of claim 1 having a modulus less than the 2 times the sum of the modulus of the first substrate, the elastic component and the second substrate in the absence of adhesion or bonding.

10. The article of claim 1 comprising a garment.

11. The article of claim 10, wherein said garment is selected from the group consisting of tops, bottoms, hosiery, seamless garments, headwear, underwear, and gloves.

12. The article of claim 1, wherein said adhesive is selected from the group consisting of a hot melt adhesive, a reactive polyurethane, a cyanoacrylate, an epoxy, polyvinyl acetate, a plastisol, a thermoplastic, silicone, a polyurethaneurea aqueous dispersion, and combinations thereof.

13. An article comprising a first substrate, a second substrate and an elastic component between said first substrate and said second substrate;
wherein said first substrate comprises a fabric having opposing sides comprising a technical face and a technical back;
said second substrate comprises a fabric or a foam;
said elastic component comprises a film or adhesive selected from the group consisting of polyurethanes, polyurethaneureas, polyolefins, and combinations thereof;
said elastic component is adhered to said first substrate and said second substrate to form bonds; at least one of said technical face or said technical back of said first substrate includes yarn structures that stretch in a selected direction selected from the group consisting of the warp direction, the weft direction, and combinations thereof;
the bonds of said elastic component to said yarn structures that stretch in the selected direction are minimized.

14. The article of claim 13, wherein the yarn structures that stretch in the selected direction of stretch are primarily on the technical face of the first substrate and the elastic component is adhered to the technical back of the first substrate.

15. The article of claim 13, wherein the yarn structures that stretch in the selected direction of stretch are primarily on the technical back of the first substrate and the elastic component is adhered to the technical face of said first substrate.

16. The article of claim 13, wherein the yarn structures that stretch in the selected direction of stretch are primarily on the technical face of the first substrate and the elastic component is adhered to the technical back of said first substrate.

17. The article of claim 13, wherein said second substrate comprises a fabric.

18. The article of claim 13, wherein said first substrate and said second substrate each comprise a fabric;
each fabric comprises a warp direction and a weft direction;
and are bonded with orientation of about 0° to about 15° or an orientation of about 75° to about 90°.

19. The article of claim 13, wherein the second substrate is a woven fabric, a warp knit fabric, or a weft knit fabric and the elastic component is bonded to the technical face of each of the first substrate and the second substrate with an orientation of about 0° to about 15°.

20. The article of claim 13, wherein the second substrate is a woven fabric, a warp knit fabric, or a weft knit fabric and the elastic component is bonded to the technical back of each of the first substrate and the second substrate with an orientation of about 0° to about 15°.

21. The article of claim 13, wherein the second substrate is a woven fabric, a warp knit fabric, or a weft knit fabric and the elastic component is bonded to the technical face of each of the first substrate and the second substrate with an orientation of 75° to about 90°.

22. The article of claim 13, wherein the second substrate is a woven fabric, a warp knit fabric, or a weft knit fabric and the elastic component is bonded to the technical face of the first substrate and the technical back of the second substrate with an orientation of 75° to about 90°.

23. An article comprising a fabric layer and an elastic component,
wherein said elastic component is a polymer film selected from the group consisting of elastomeric polyolefins and polyurethanes;
said fabric layer includes a selected direction of stretch selected from the warp direction, the weft direction, and combinations thereof;
said fabric layer includes stretchable yarn structures that stretch in the selected direction of stretch;
said elastic component is adhered to said fabric layer to form bonds; and
said bonds between the elastic component and yarn structures that stretch in the selected direction of stretch are minimized.

24. A method of preparing an article comprising a fabric layer and an elastic component, said method comprising
providing an said elastic component as a polymer film selected from the group consisting of elastomeric polyolefins and polyurethanes;
providing a fabric layer including a selected direction of stretch selected from the warp direction, the weft direction, and combinations thereof wherein said fabric layer includes stretchable yarn structures that stretch in the selected direction of stretch;
adhering said elastic component to said fabric layer to form bonds; and
minimizing the bonds between the elastic component and yarn structures that stretch in the selected direction of stretch.

25. The method of claim 24 further comprising the step of adhering said elastic component to an additional substrate.

26. A method of preparing an article comprising providing a first substrate, a second substrate and a bonding component between said first substrate and said second substrate;
wherein said bonding component is selected from the group consisting of an elastomeric polymer film, an adhesive, and combinations thereof;
at least one of said first substrate and said second substrate includes a fabric layer;
said first substrate and said second substrate together include a selected direction of stretch selected from the warp direction, the weft direction, and combinations thereof;
at least one of said first substrate and said second substrate independently include stretchable yarn structures that stretch in a direction selected form the group consisting of the warp direction, the weft direction, and combinations thereof;
adhering said elastic component to said first substrate and said second substrate to form bonds; and
minimizing said bonds between the elastic component and yarns in selected direction of stretch.
